(19) United States
(12) Patent Application Publication
(10) Pub. No.: US 2020/0160045 A1
(43) Pub. Date: May 21, 2020

(54) IMAGE PROCESSING DEVICE

(71) Applicant: AISIN SEIKI KABUSHIKI KAISHA, Kariya-shi (JP)

(72) Inventors: Kazuya MORI, Kariya-shi (JP); Toshifumi Haishi, Kariya-shi (JP)

(73) Assignee: AISIN SEIKI KABUSHIKI KAISHA, Kariya-shi (JP)

(21) Appl. No.: 16/681,969

(22) Filed: Nov. 13, 2019

(30) Foreign Application Priority Data
Nov. 19, 2018 (JP) 2018-216791

(51) Int. Cl. G06K 9/00; G06T 7/20

(52) U.S. Cl. CPC G06K 9/00342; G06T 2207/30196; G06T 7/20; G06K 9/00362

(57) ABSTRACT

An image processing device includes: a moving body detecting unit configured to detect a moving body region from a captured image; a setting unit configured to set a reference point and a plurality of straight lines extending radially from the reference point with respect to an image indicating a position and a size of the moving body region in the captured image; a ratio calculating unit configured to calculate a ratio of the moving body region occupying each of the straight lines or each region which is between two adjacent straight lines; and a shadow determining unit configured to determine whether or not a shadow is included in the moving body region based on the number of the straight lines or the regions the ratio of which is equal to or greater than a threshold value.

### CROSS REFERENCE TO RELATED APPLICATIONS

This application is based on and claims priority under 35 U.S.C. § 119 to Japanese Patent Application 2018-216791, filed on Nov. 19, 2018, the entire contents of which are incorporated herein by reference.

### TECHNICAL FIELD

This disclosure relates to an image processing device.

### BACKGROUND DISCUSSION

In related art, an image processing device that detects a shadow from a captured image is known. For example, JP 2011-95977A (Reference 1) discloses a technology in which a horizontal edge is detected based on a horizontal edge histogram derived from captured images, so that obstacle candidates around a vehicle are detected, and a shadow projected on a road surface is detected from the obstacle candidates based on a characteristic of a contour shape formed by a peak of the horizontal edge histogram.

Specifically, in the technology described in Reference 1, an obstacle candidate that has a high peak at each of an upper end and a lower end in the horizontal edge histogram and is shown in a substantially recessed shape which is flat between the upper end and the lower end is detected as the shadow projected on the road surface.

However, in the related art, when the road surface is tiled or in a block shape, an edge is also generated in a part of the shadow, so that the shape is not necessarily to be substantially recessed and the shadow may not be appropriately detected.

### SUMMARY

This disclosure provides, as an example, an image processing device that can appropriately detect a shadow from a captured image.

An image processing device according to an aspect of this disclosure includes, as an example, a moving body detecting unit configured to detect a moving body region from a captured image, a setting unit configured to set a reference point and a plurality of straight lines extending radially from the reference point with respect to an image indicating a position and a size of the moving body region in the captured image, a ratio calculating unit configured to calculate a ratio of the moving body region occupying each of the straight lines or each region which is between two adjacent straight lines, and a shadow determining unit configured to determine whether or not a shadow is included in the moving body region based on the number of the straight lines or the regions the ratio of which is equal to or greater than a threshold value. Therefore, as an example, a texture such as an edge of an image is not used, so that shadow determination can be performed regardless of a type of ground. Therefore, the shadow can appropriately be detected from the captured image.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic plan view of a vehicle to which an image processing device according to an embodiment is applied;

FIG. 2 is a block diagram illustrating the configuration of a vehicle control system according to the embodiment;

FIG. 3 is a block diagram illustrating a functional configuration of an ECU according to the embodiment;

FIG. 4 illustrates an example of a captured image to be input to the ECU;

FIG. 5 illustrates an example of a difference image obtained by applying a background difference method to the captured image illustrated in FIG. 4;

FIG. 6 is an illustrative diagram of labeling processing;

FIG. 7 illustrates an example of the difference image after noise removing processing;

FIG. 8 illustrates an example of the difference image in which a reference point and a plurality of straight lines extending radially from the reference point are set;

FIG. 9 is an illustrative diagram of shadow region specifying processing;

FIG. 10 is an illustrative diagram of feet estimating processing; and

FIG. 11 is a flowchart illustrating an example of an image processing procedure executed by the ECU.

### DETAILED DESCRIPTION

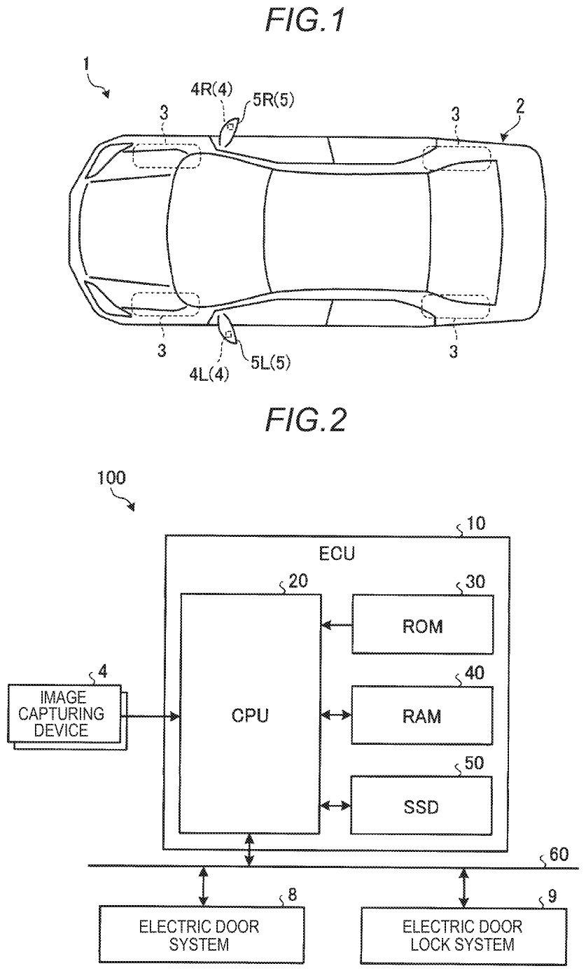

Firstly, the configuration of a vehicle to which an image processing device according to an embodiment is applied will be described with reference to FIG. 1. FIG. 1 is a schematic plan view of the vehicle to which the image processing device according to the embodiment is applied.

A vehicle 1 may be an automobile (internal combustion engine automobile) using an internal combustion engine (engine) as a driving source, an automobile (an electric automobile, a fuel-cell vehicle, and the like) using an electric motor (motor) as the drive source, or an automobile (hybrid automobile) using both of them as the driving sources. The vehicle 1 can be mounted with various speed change devices and various devices (systems, components, and the like) necessary for driving the internal combustion engine and the electric motor. Further, methods, numbers, layouts, and the like of devices related to wheels driving in the vehicle 1 can be variously set.

As illustrated in FIG. 1, the vehicle 1 according to the embodiment is, for example, a four-wheeled automobile having four wheels 3 in total on the front, rear, left and right.

The vehicle 1 is provided with a plurality of image capturing devices 4. The image capturing device 4 is an image capturing device including an image capturing device such as a charge coupled device (CCD) or a CMOS image sensor (CIS). The image capturing device 4 can output captured image data (moving image data, frame data) at a predetermined frame rate.

The vehicle 1 is provided with two image capturing devices 4L and 4R in the embodiment. The image capturing device 4L is provided on a side mirror 5L on a left side of the vehicle 1, and the image capturing device 4R is provided on a side mirror 5R on a right side of the vehicle 1. Further, the image capturing device 4 is not necessarily provided on a side mirror 5 and may be provided at a position other than the side mirror 5 on a vehicle body 2.

Optical axes of the image capturing devices 4L and 4R are fixed downward such as vertically downward or obliquely downward. Thereby, the image capturing devices 4L and 4R according to the embodiment can capture images of situations around the vehicle body 2 including a road surface and a region above the road surface.

The vehicle 1 is provided with a vehicle control system including the image processing device according to the embodiment. The configuration of the vehicle control system will be described with reference to FIG. 2. FIG. 2 is a block diagram illustrating the configuration of the vehicle control system according to the embodiment.

As illustrated in FIG. 2, a vehicle control system 100 includes, in addition to an electronic control unit (ECU) 10, an electric door system 8, an electric door lock system 9 and the like which are electrically connected with each other via an in-vehicle network 60 serving as a telecommunication circuit.

The in-vehicle network 60 is configured as, for example, a controller area network (CAN). The ECU 10 can control the electric door system 8, the electric door lock system 9, and the like by sending a control signal through the in-vehicle network 60.

The electric door system 8 opens and closes electric doors such as a power sliding door, a power back door and a power swing door provided in the vehicle 1 under the control of the ECU 10. The electric door lock system 9 locks or unlocks the doors provided in the vehicle 1 under the control of the ECU 10.

The ECU 10 includes, for example, a central processing unit (CPU) 20, a read only memory (ROM) 30, a random access memory (RAM) 40, a solid state drive (SSD) 50, and the like.

The CPU 20 controls the entire vehicle 1. The CPU 20 can read a program installed and stored in a nonvolatile storage device such as the ROM 30, and can execute arithmetic processing according to the program. The RAM 40 temporarily stores various data used in the arithmetic processing executed by the CPU 20. The SSD 50 is a rewritable nonvolatile storage unit, and can store the data even when power of the ECU 10 is turned off. The CPU 20, the ROM 30, the RAM 40, and the like can be integrated in a same package. The ECU 10 may have a configuration in which another logic operation processor such as a digital signal processor (DSP), or a logic circuit, or the like is used instead of the CPU 20. Further, a hard disk drive (HDD) may be provided instead of the SSD 50, and the SSD 50 or the HDD may be provided separately from the ECU 10.

The ECU 10 is connected with the plurality of image capturing devices 4 described above. The plurality of image capturing devices 4 capture the images of the situations around the vehicle body 2 including the road surface and the region above the road surface, and output the captured images to the ECU 10.

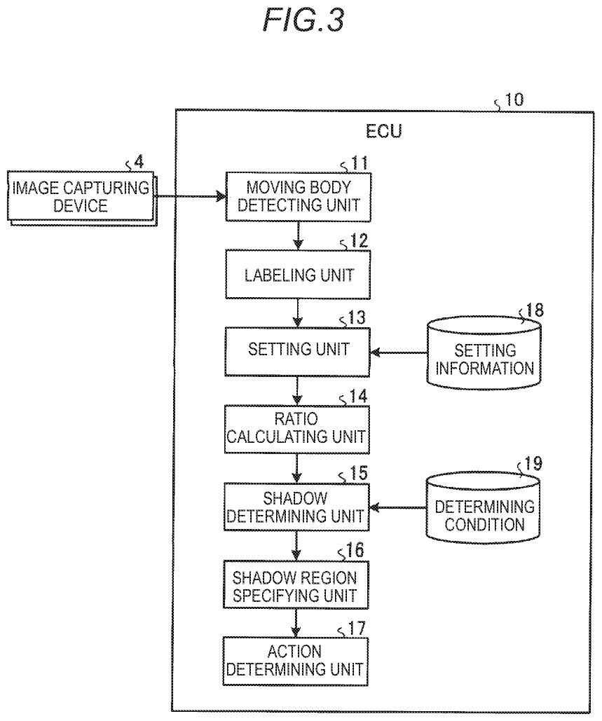

Next, a functional configuration of the ECU 10 will be described with reference to FIG. 3. FIG. 3 is a block diagram illustrating the functional configuration of the ECU 10 according to the embodiment. FIG. 3 only illustrates the functional configuration as the image processing device in the functional configurations of the ECU 10, and other functional configurations such as a functional configuration related to vehicle control are omitted.

As illustrated in FIG. 3, the ECU 10 includes a moving body detecting unit 11, a labeling unit 12, a setting unit 13, a ratio calculating unit 14, a shadow determining unit 15, a shadow region specifying unit 16 and an action determining unit 17. These are implemented by the CPU 20 configured as the ECU 10 executing the program stored in the ROM 30. These configurations may be implemented by hardware.

Further, the ECU 10 stores setting information 18 and a determining condition 19. The setting information 18 and the determining condition 19 are stored in a storage medium such as the SSD 50.

The moving body detecting unit 11 detects a moving body region from the captured image acquired by the image capturing device 4. The moving body region here means a region where a moving body exists in an image region of the captured image. For example, the moving body detecting unit 11 can detect the moving body region from the captured image by a background-difference method, expansion/reduction processing, outline extraction processing, or a combination thereof.

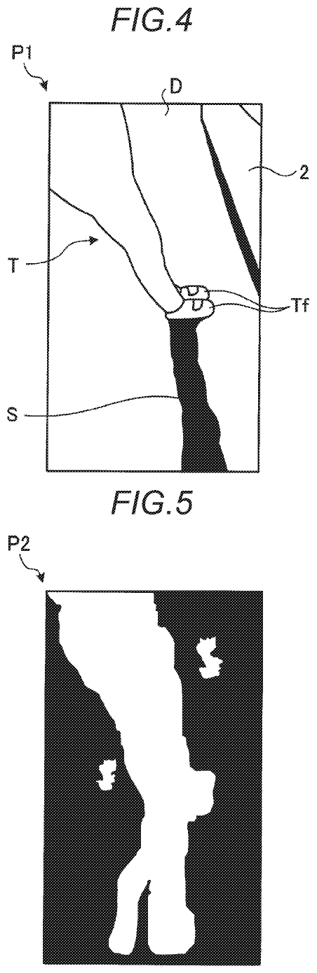

FIG. 4 illustrates an example of a captured image input to the ECU. FIG. 4 illustrates an example of a captured image P1 received from the image capturing device 4R provided on the right side of the vehicle body 2. As illustrated in FIG. 4, the captured image P1 includes a road surface D, feet Tf of a person T which is a target, and a shadow S of the person T extending from the feet Tf. Moreover, the captured image P1 includes the right side surface of the vehicle body 2.

FIG. 5 illustrates an example of a difference image obtained by applying the background-difference method to the captured image illustrated in FIG. 4. In a difference image P2 illustrated in FIG. 5, the moving body region is represented by white, and a background region other than the moving body region is represented by black.

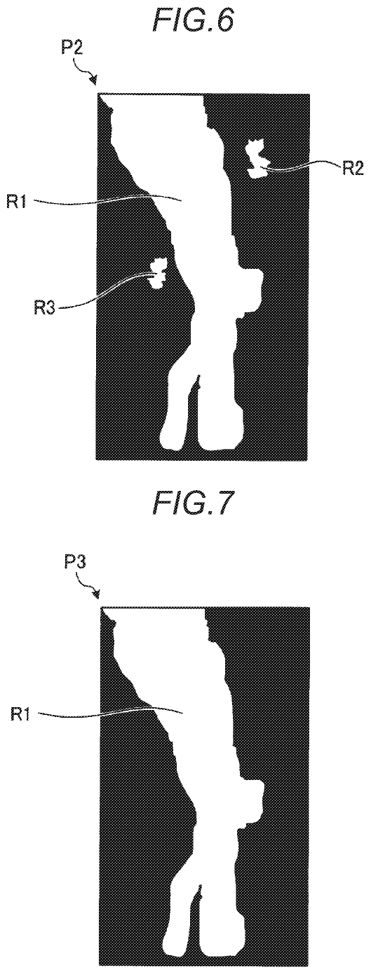

The labeling unit 12 labels each region, so that the moving body region detected by the moving body detecting unit 11 is distinguished from the regions. FIG. 6 is an illustrative diagram of labeling processing. As illustrated in FIG. 6, the difference image P2 includes three moving body regions separated by the background region, and the labeling unit 12 labels these three moving body regions. Here, labels of “R1”, “R2”, and “R3” are respectively given to the three moving body regions. Among these regions, the moving body region R1 is a region including the person T and the shadow S of the person T.

Further, the labeling unit 12 performs noise removing processing to exclude a moving body region whose size is less than a threshold value from objects of ratio calculating processing to be performed by the ratio calculating unit 14, shadow determining processing to be performed by the shadow determining unit 15 and the like which are described below. For example, for each of the moving body regions R1 to R3, the labeling unit 12 measures the number of pixels included in the respective moving body regions R1 to R3, and removes a moving body region (R1, R2, or R3) whose measured pixel number is less than the threshold value from the difference image P2.

FIG. 7 illustrates an example of the difference image after the noise removing processing. As illustrated in FIG. 7, a difference image P3 is obtained by the noise removing processing in which the moving body regions R2 and R3 having the size less than the threshold value are removed from the moving body regions R1 to R3.

In the ECU 10 according to the embodiment, the action determining unit 17 described below determines whether the person T is in a standing still action. Here, a position where the person T stands still, that is, a position where a standing-still determination is valid (determination area described below) is determined in advance, and a position and an angle of view of the image capturing device 4 are also determined in advance. Therefore, a position and a size of the person T included in the captured image P1 can be predicted in advance. The threshold value used in the noise removing processing is set based on the size of the person T predicted in advance. Thereby, the small moving body regions R2 and R3 that cannot be the person T can be removed from the difference image P2 as noise.

The difference images P2 and P3 are examples of “an image indicating a position and a size of the moving body region in the captured image”.

The setting unit 13 sets a reference point and a plurality of straight lines extending radially from the reference point in the difference image P3 after the noise removing processing.

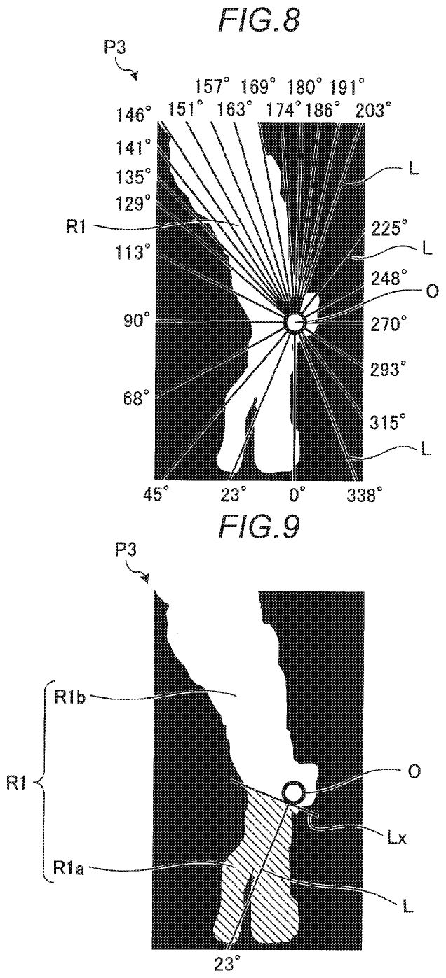

FIG. 8 illustrates an example of the difference image P3 in which the reference point and the plurality of straight lines extending radially from the reference point are set. As illustrated in FIG. 8, one reference point O and a plurality of (here, 25) straight lines L are set in the difference image P3.

The reference point O is set to a central coordinate of the determination area in which an action determination (determination on whether the person T is in the standing still action) performed by the action determining unit 17 described below is valid. In other words, the reference point O is set at the position predicted to be where the person T is standing still. The reference point O only needs to be set within the determination area, and does not necessarily need to be set to the central coordinates of the determination area.

The plurality of straight lines L is set radially with the reference point O as a center. As described above, the position and the size of the person T reflected in the captured image P1 can be predicted in advance. Therefore, the setting unit 13 may set intervals between the straight lines L in an angular range pre-set to be an angular range in which the person T is highly likely to exist in the difference image P3 to be smaller than intervals between the straight lines L in the others angular ranges. For example, in the example illustrated in FIG. 8, intervals between the straight lines L in an angular range of 129° to 203° is set smaller than intervals between the straight lines L in the other angular range. Thereby, existence of the person T can be determined more accurately.

The setting unit 13 sets the reference point O and the plurality of straight lines L according to the setting information 18 described above. The setting information 18 includes information such as a coordinate position of the reference point O in the difference image P3 and angles of each straight line L. The setting information 18 can be appropriately changed.

The ratio calculating unit 14 calculates a ratio (hereinafter referred to as “direction strength”) of the moving body region R1 occupying the straight lines L for each of the plurality of straight lines L. Specifically, when the direction intensity is I, the number of pixels in the moving body region R1 on the straight lines L is Pxm, and the number of pixels in the background region on the straight lines is Pxb, the direction intensity I is calculated by a formula I=Pxm/(Pxm+Pxb).

The ratio calculating unit 14 calculates the direction strength of each straight line L, and stores calculation results in the storage medium such as the SSD 50.

The shadow determining unit 15 determines whether or not the moving body region R1 includes the person T and whether or not the moving body region R1 includes a shadow based on the calculation results of the ratio calculating unit 14 and the determining condition 19.

The determining condition 19 is set based on a pre-investigation result of a tendency of the direction strength when a person stands in the determination area under a condition under which the shadow is possible and a condition under which the shadow is not possible. Imaging conditions in the above pre-investigation are the same as those of the image capturing devices 4L and 4R, and thus, the determining condition 19 is stored for each of the image capturing devices 4L and 4R.

The determining condition 19 includes “person-like object determining conditions” and “shadow-like object determining conditions”. The shadow determining unit 15 firstly uses the “person-like object determining conditions” to perform person-like object determining processing for determining whether or not the person T exists in the moving body region R1.

For example, the shadow determining unit 15 determines whether or not a first person-like object determining condition, that is, there are five continuing straight lines L with the direction strength of 0.55 or more in an angular range of 129° to 163°, is satisfied (first person-like object determining processing). Whether or not the moving body region R1 is included in a region where the person T is likely to exist in the captured image P1 at a certain ratio or more is determined in the first person-like object determining processing.

Further, the shadow determining unit 15 determines whether or not a second person-like object determining condition, that is, there are two or more straight lines L with the direction strength of 0.25 or less in angular ranges of 0° to 129° and 180° to 360° (0°), is satisfied (second person-like object determining processing). Whether or not the moving body region R1 is included in a region where the person T is unlikely to exist in the captured image P1 at the certain ratio or more is determined in the second person-like object determining processing.

When the first person-like object determining condition and the second person-like object determining condition are satisfied, the shadow determining unit 15 determines that the person T exists in the moving body region R1. In this way, when, for example, an object (such as a vehicle) larger than a person exists in the determination area, a wrong determination that the person T exists in the moving body region R1 can be suppressed by performing the first person-like object determining processing and the second person-like object determining processing.

Here, in the person-like object determining processing, the first person-like object determining processing and the second person-like object determining processing are performed, but the shadow determining unit 15 may only perform the first person-like object determining processing.

When the shadow determining unit 15 determines that the person T exists in the moving body region R1 in the person-like object determining processing, the shadow determining unit 15 uses the “shadow-like object determining conditions” to perform shadow-like object determining processing for determining whether or not the shadow exists in the moving body region R1.

For example, the shadow determining unit 15 determines whether or not a shadow-like object determining condition, that is, there is one or more straight lines L with the direction strength of 0.25 or more in angular ranges of 0° to 90° and 225° to 360°, is satisfied. Then, when the shadow-like object determining condition is satisfied, the shadow determining unit 15 determines that the shadow exists in the moving body region R1.

When the shadow determining unit 15 determines that the shadow exists in the moving body region R1, the shadow region specifying unit 16 specifies a shadow region where the shadow exists in the moving body region R1 based on “straight lines L with the direction strength of 0.25 or more in the angular ranges of 0° to 90° and 225° to 360°” in the shadow-like object determining condition.

In the above-described example, the ratio calculating unit 14 calculates the ratio of the moving body region R1 occupying the straight lines L as the direction strength, but the ratio calculating unit 14 may also calculate a ratio of the moving body region R1 occupying a region which is between two adjacent straight lines L as the direction strength. In this case, the direction intensity I is calculated by the formula: I=Pxm/(Pxm+Pxb), in which the Pxm is the number of pixels of the moving body region R1 in the region sandwiched between the two adjacent straight lines L, and Pxb is the number of pixels of the background region in the region sandwiched between the two adjacent straight lines L. In this case, the shadow determining unit 15 determines whether or not the shadow is included in the moving body region R1 based on the number of the above-mentioned region whose direction intensity is equal to or greater than the threshold value.

When the image capturing device 4 is provided on the side mirror 5, an imaging range of the image capturing device 4 changes depending on an opening/closing angle of the side mirror 5. Therefore, the ECU 10 may store a plurality of setting information 18 and determining conditions 19 associated with the opening/closing angle of the side mirror 5. In this case, the setting unit 13 may set the reference point O and the plurality of straight lines L by using the setting information 18 associated with a current opening/closing angle of the side mirror 5 among the plurality of setting information 18. The shadow determining unit 15 may perform the person-like object determining processing and the shadow-like object determining processing by using the determining condition 19 associated with the current opening/closing angle of the side mirror 5 among the plurality of determining conditions 19.

FIG. 9 is an illustrative diagram of shadow region specifying processing. As illustrated in FIG. 9, it is assumed that “a straight line L with the direction strength of 0.25 or more in the angular ranges of 0° to 90°, 225° to 360°” is a straight line L having an angle of 23°. In this case, the shadow region specifying unit 16 sets a straight line Lx that passes a starting point (contact point of the straight line L having the angle of 23° and the reference point O) of the straight line L having the angle of 23° and is perpendicular to the straight line L having the angle of 23°. Further, in the moving body region R1 divided by the straight line Lx, the shadow region specifying unit 16 specifies a region including the straight line L having the angle of 23° as a shadow region R1a, and specifies a region other than the shadow region R1a as a person region R1b. Then, the shadow region specifying unit 16 removes the shadow region R1a from the difference image P3.

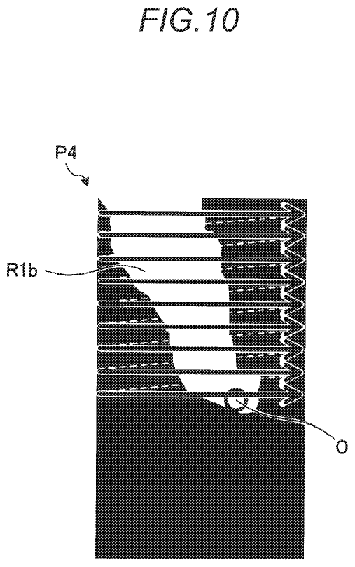

The action determining unit 17 determines an action of the person T based on the person region R1b. First, the action determining unit 17 performs feet estimating processing for estimating positions of the feet of the person T. FIG. 10 is an illustrative diagram of the feet estimating processing.

As illustrated in FIG. 10, the action determining unit 17 scans the uppermost row of a difference image P4 from which the shadow region R1a is removed, and determines whether or not the number of pixels of the person region R1b in the row is equal to or less than the threshold value. During this determination, when the number of pixels in the person region R1b exceeds the threshold value, the action determining unit 17 scans a next row and determines whether the number of pixels in the person region R1b in the row is equal to or less than the threshold value. The action determining unit 17 repeats this determination until the number of pixels in the person region R1b is equal to or less than the threshold value. Then, a position where the number of pixels of the person region R1b is equal to or less than the threshold value is estimated as the feet position of the person T.

Subsequently, the action determining unit 17 measures time during which the estimated feet of the person T exist in the determination area, and determines that the person T is in the standing still action when the measured time exceeds a threshold value. For example, the action determining unit 17 measures the number of consecutive frames in which the feet of the person T exist in the determination area, and determines that the person T is in the standing still action when the measured number exceeds a threshold value.

When it is determined that the person T is in the standing still action, for example, the ECU 10 controls the electric door lock system 9 to lock or unlock the door corresponding to the image capturing device 4 that captures images of the person T. Alternatively, the ECU 10 may control the electric door system 8 to open and close the electric door corresponding to the image capturing device 4 that captures images of the person T.

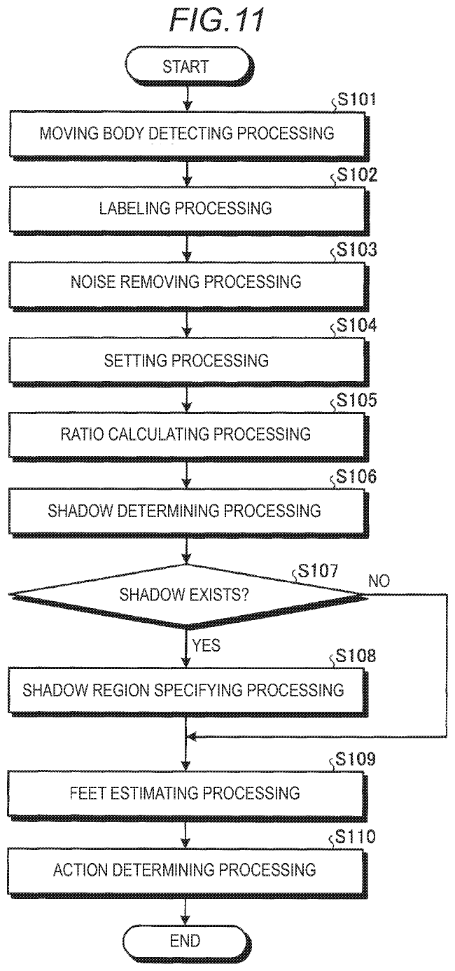

Next, an image processing procedure executed by the ECU 10 will be described with reference to FIG. 11. FIG. 11 is a flowchart illustrating an example of the processing procedure executed by the ECU 10.

As illustrated in FIG. 11, the ECU 10 performs moving body detecting processing on the captured image P1 received from the image capturing device 4. In the moving body detecting processing, the ECU 10 detects the moving body regions R1 to R3 from the captured image P1 (step S101). Subsequently, the ECU 10 performs the labeling processing (step S102). In the labeling processing, the ECU 10 labels the detected moving body regions R1 to R3.

Subsequently, the ECU 10 performs the noise removing processing (step S103). In the noise removing processing, the ECU 10 removes the moving body regions R2 and R3 having the size less than the threshold value among the moving body regions R1 to R3 from the difference image P2

Subsequently, the ECU 10 performs setting processing (step S104). In the setting processing, the ECU 10 sets the reference point O and the plurality of straight lines extending radially from the reference point O in the difference image P3 after the noise removing processing. Further, the ECU 10 performs the ratio calculating processing (step S105). In the ratio calculating processing, the ECU 10 calculates the direction strength of each straight line L.

Subsequently, the ECU 10 performs the shadow determining processing (step S106). In the shadow determining processing, the ECU 10 performs “the person-like object determining processing” and “the shadow-like object determining processing” based on the determining condition 19. Subsequently, the ECU 10 determines whether or not the shadow S exists in the moving body region R1 (step S107).

In the step S107, when it is determined that the shadow S exists (step S107, Yes), the ECU 10 performs the shadow region specifying processing (step S108). In the shadow region specifying processing, the ECU 10 specifies the shadow region R1a, and removes the specified region R1a from the difference image P3.

When the processing of the step S108 is completed, or when the shadow S does not exist in the moving body region R1 in step S107 (step S107, No), the ECU 10 performs the feet estimating processing (step S109). In the feet estimating processing, the ECU 10 estimates positions of the feet of the person T. Subsequently, the ECU 10 performs action determining processing (step S110). In the action determining processing, the ECU 10 measures the time during which the estimated feet of the person T exist in the determination area, and determines that the person T is in the standing still action when the measured time exceeds the threshold value. When the processing of step S110 is completed, the ECU 10 ends the process.

As described above, the image processing device (ECU 10 as an example) according to the embodiment includes the moving body detecting unit 11, the setting unit 13, the ratio calculating unit 14 and the shadow determining unit 15. The moving body detecting unit 11 detects the moving body regions R1 to R3 from the captured image P1. The setting unit 13 sets the reference point O and the plurality of straight lines L extending radially from the reference point O in the image (for example, the difference image P2) indicating the positions and the sizes of the moving body regions R1 to R3 in the captured image P1. The ratio calculating unit 14 calculates a ratio (for example, the direction strength) of the moving body region R1 occupying each region sandwiched between two adjacent straight lines L or on each straight line L. The shadow determining unit 15 determines whether or not a shadow is included in the moving body region R1 based on the number of the straight lines L or the regions of which the ratio is equal to or greater than the threshold value. Therefore, as an example, since a texture such as an edge of an image is not used, shadow determination can be performed regardless of a type of ground.

Further, for example, JP 2010-204941A discloses a technology that efficiently and accurately eliminates shadow images from movement images that contain shadows without adopting a difference method that uses background images (texture), but by using a characteristic “the shadow contains color information of the projected destination, the saturation and hue of the background color maintained, and only the lightness is degraded”. According to the technology, when there is little spread of color space, such as the color of an object is black or gray, accurate shadow determination may become difficult. In contrast, according to the image processing device according to the embodiment, since conditions of the color space are not used, the shadow determination can be performed even in a case where the color space is not wide enough.

Further, J P 2008-245063A discloses a technology in which the shadow created by a reference object is captured, the reference brightness and color distribution for each color component are extracted, and regions with similar distribution are determined as shadows. According to the technology, since setting the reference object is necessary, it may be difficult to apply when the camera itself moves. In contrast, according to the image processing device according to the embodiment, since setting the reference object is not necessary, the image processing device is easy to be applied to the vehicle control system 100 as in the present embodiment.

As described above, according to the image processing device of the embodiment, a shadow can be appropriately detected from a captured image.

In addition, in the image processing device (ECU 10 as an example) according to the embodiment, when the number of the straight lines L or the regions of which the ratio is equal to or greater than a first threshold value satisfies a first condition (the first person-like object determining condition as an example) in a first angular range setting the reference point O as the center, the shadow determining unit 15 performs the first determining processing (first person-like object determining processing as an example) to determine that a target (person T as an example) exists in the moving body region R1; when it is determined that the object exists in the first determining processing, and the number of the straight lines L or the regions of which the ratio is equal to or greater than a second threshold value satisfies a second condition (the shadow-like object determining condition as an example) in a second angular range setting the reference point O as the center, the shadow determining unit 15 performs the second determining processing (the shadow-like object determining processing as an example) to determine that the shadow S exists in the moving body region R1. Therefore, as an example, the target and the shadow thereof included in the captured image can be accurately determined.

The image processing device (ECU 10 as an example) according to the embodiment includes the shadow region specifying unit 16. When the shadow determining unit 15 determines that the shadow S exists in the moving body region R1, the shadow region specifying unit 16 specifies the shadow region R1a where the shadow S exists in the moving body region R1 based on the straight lines L or the regions (the straight line L having the angle of 23° as an example) of which the ratio is equal to or greater than the second threshold value in a second angular range. Therefore, as an example, the moving body region R1 can be divided into the shadow region R1a and a target region (the person region R1b as an example).

The image processing device (ECU 10 as an example) according to the embodiment includes the action determining unit 17. The action determining unit 17 determines an action of the target (the person T as an example) based on the target region (the person region R1b as an example) which is a region other than the shadow region R1a in the moving body region R1. Therefore, as an example, since the shadow is not included in the target region, the action of the target can be accurately determined.

In the image processing device (ECU 10 as an example) according to the embodiment, the action determining unit 17 determines an action of the target (the person T as an example) in the determination area. Further, the setting unit 13 sets the reference point O in the determination area. Therefore, as an example, the reference point O and the plurality of straight lines L can be set at appropriate positions.

In the above-described embodiment, the standing still action of the person is determined in the action determining processing, but the action that is a target of the action determining processing does not necessarily have to be the standing still action, for example, the action can be raising feet in the determination area. Further, in the above-described embodiment, an example in which the target is a person has been described, but the target does not necessarily need to be a person, for example, the target may be an animal such as a dog or a cat, and may be a robot or the like.

An image processing device according to an aspect of this disclosure includes, as an example, a moving body detecting unit configured to detect a moving body region from a captured image, a setting unit configured to set a reference point and a plurality of straight lines extending radially from the reference point with respect to an image indicating a position and a size of the moving body region in the captured image, a ratio calculating unit configured to calculate a ratio of the moving body region occupying each of the straight lines or each region sandwiched between two adjacent straight lines, and a shadow determining unit configured to determine whether or not a shadow is included in the moving body region based on the number of the straight lines or the regions the ratio of which is equal to or greater than a threshold value. Therefore, as an example, a texture such as an edge of an image is not used, so that shadow determination can be performed regardless of a type of ground. Therefore, the shadow can appropriately be detected from the captured image.

In the image processing device, as an example, the shadow determining unit may perform first determining processing to determine that a target exists in the moving body region when the number of the straight lines or the regions the ratio of which is equal to or greater than a first threshold value satisfies a first condition in a first angular range with the reference point as a center, and perform second determining processing to determine that a shadow exists in the moving body region when it is determined that the target exists in the first determining processing, and the number of the straight lines or the regions the ratio of which is equal to or greater than a second threshold value satisfies a second condition in a second angular range with the reference point as the center. Therefore, as an example, the target and the shadow thereof in the captured image can be accurately determined.

As an example, the image processing device may further include a shadow region specifying unit configured to specify a shadow region where the shadow exists in the moving body region based on the straight lines or the regions the ratio of which is equal to or greater than the second threshold value in the second angular range, when the shadow determining unit determines that the shadow exists in the moving body region. Therefore, as an example, the moving body region can be divided into the shadow region and a target region.

As an example, the image processing device may further include an action determining unit configured to determine an action of the target based on a target region which is a region other than the shadow region in the moving body region. Therefore, as an example, the shadow is not included in the target region, so that the action of the target can be accurately determined.

In the image processing device, as an example, the action determining unit may determine the action of the target in a determination area, and the setting unit sets the reference point in the determination area. Therefore, as an example, the reference point and the plurality of straight lines can be set at appropriate positions.

In the image processing device, as an example, the setting unit may set a central coordinate of the determination area as the reference point.

In the image processing device, as an example, the setting unit sets intervals between straight lines in a predetermined angular range to be smaller than intervals between straight lines in an angular range which is different from the predetermined angular range.

An image processing device according to another aspect of this disclosure includes, as an example, a controller, and the controller is configured to detect a moving body region from a captured image, set a reference point and a plurality of straight lines extending radially from the reference point with respect to an image indicating a position and a size of the moving body region in the captured image, calculate a ratio of the moving body region occupying each of the straight lines or each region sandwiched between two adjacent straight lines, and determine whether or not a shadow is included in the moving body region based on the number of the straight lines or the regions the ratio of which is equal to or greater than a threshold value.

While embodiments disclosed here have been described, these embodiments and modifications have been presented by way of example only, and are not intended to limit the scope of the inventions. Indeed, the embodiments and the modifications described herein may be embodied in a variety of other forms; furthermore, various omissions, substitutions and changes in the form of the embodiments described herein may be made without departing from the spirit of the inventions. The configurations and shapes of the respective embodiments and each modification can be partly exchanged.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An image processing device comprising:
a moving body detecting unit configured to detect a moving body region from a captured image;
a setting unit configured to set a reference point and a plurality of straight lines extending radially from the reference point with respect to an image indicating a position and a size of the moving body region in the captured image;
a ratio calculating unit configured to calculate a ratio of the moving body region occupying each of the straight lines or each region which is between two adjacent straight lines; and
a shadow determining unit configured to determine whether or not a shadow is included in the moving body region based on the number of the straight lines or the regions the ratio of which is equal to or greater than a threshold value.

2. The image processing device according to claim 1, wherein
the shadow determining unit performs first determining processing to determine that a target exists in the moving body region when the number of the straight lines or the regions the ratio of which is equal to or greater than a first threshold value satisfies a first condition in a first angular range with the reference point as a center, and performs second determining processing to determine that a shadow exists in the moving body region when it is determined that the target exists in the first determining processing, and the number of the straight lines or the regions the ratio of which is equal to or greater than a second threshold value satisfies a second condition in a second angular range with the reference point as the center.

3. The image processing device according to claim 2, further comprising:
a shadow region specifying unit configured to specify a shadow region where the shadow exists in the moving body region based on the straight lines or the regions the ratio of which is equal to or greater than the second threshold value in the second angular range, when the shadow determining unit determines that the shadow exists in the moving body region.

4. The image processing device according to claim 3, further comprising:
an action determining unit configured to determine an action of the target based on a target region which is a region other than the shadow region in the moving body region.

5. The image processing device according to claim 4, wherein
the action determining unit determines the action of the target in a determination area, and
the setting unit sets the reference point in the determination area.

6. The image processing device according to claim 5, wherein
the setting unit sets a central coordinate of the determination area as the reference point.

7. The image processing device according to claim 1, wherein
the setting unit sets intervals between straight lines in a predetermined angular range to be smaller than intervals between straight lines in an angular range which is different from the predetermined angular range.

8. An image processing device comprising:
a controller, wherein
the controller is configured to
detect a moving body region from a captured image,
set a reference point and a plurality of straight lines extending radially from the reference point with respect to an image indicating a position and a size of the moving body region in the captured image,
calculate a ratio of the moving body region occupying each of the straight lines or each region which is between two adjacent straight lines, and
determine whether or not a shadow is included in the moving body region based on the number of the straight lines or the regions the ratio of which is equal to or greater than a threshold value.
